(19) United States
(12) Patent Application Publication
(10) Pub. No.: US 2008/0292124 A1
(43) Pub. Date: Nov. 27, 2008

(54) HEARING AID PROTECTION DEVICE

(76) Inventors: Ray Rosenow, Lincoln, NE (US); Carey Cook, Lincoln, NE (US)

Correspondence Address: HUSCH BLACKWELL SANDERS LLP, 1620 DODGE STREET, SUITE 2100, OMAHA, NE, 68102, US

(21) Appl. No.: 12/122,202

(22) Filed: May 16, 2008

Related U.S. Application Data
(60) Provisional application No. 60/938,902, filed on May 18, 2007.

(51) Int. Cl. H04R 25/00

(52) U.S. Cl. 381/322

(57) ABSTRACT

The present invention generally relates to hearing aids, and more particularly, to a hearing aid shield configured to prevent corrosion from moisture. A hearing aid protection device is disclosed. The hearing aid protection device comprises a base, the base having a contoured edge, an upper edge, an inner surface and an outer surface, and a ridge coupled to the base proximate to the upper edge of the base, the ridge extending away from the base. The contoured edge is configured to generally accommodate a rear saddleback portion of a user's ear.

### CROSS-REFERENCE TO RELATED APPLICATION

This application claims the benefit of and priority to U.S. Provisional Patent Application No. 60/938,902, filed May 18, 2007, entitled HEARING AID PROTECTION DEVICE, which document is hereby incorporated by reference to the extent permitted by law.

### BACKGROUND OF THE INVENTION

1. Field of the Invention

The present invention generally relates to hearing aids, and more particularly, to a hearing aid shield configured to prevent corrosion from moisture.

2. Description of Related Art

A hearing aid is a device used to help hard-of-hearing people hear sounds better. According to US government statistics (National Center for Health Statistics), it has been estimated that approximately eight percent (8%) of the population in the United States suffers from some degree of hearing loss. Many people who have a severe hearing loss use behind-the-ear hearing aids, also known as “BTE” hearing aids, since the smaller inner ear and ear canal types of hearing aids will not provide enough amplification. Behind-the-ear (“BTE”) or Over-the-ear (“OTE”) hearing aids have a plastic housing for the components which rests behind the ear. A clear plastic tube and a custom made earmould funnels amplified sound into the ear canal. BTEs can be used for mild to profound hearing losses and are especially useful for children because of their durability and ability to connect to assistive listening devices such as classroom FM systems. A BTE hearing aid is a combination of amplifier, microphone and control mechanism that is typically housed in an arcuate body and has a sound tube connected to the amplifier that transmits sounds directly into a person's ear. The BTE hearing aid is typically worn over the upper rear portion of a person's ear.

Today's hearing instruments are required to do much more than just amplify sound. Many people wearing hearing instruments lead very dynamic lifestyles, which require innovative and dynamic products. Features such as directional microphone technology, multiple memories, remote controls, digital noise reduction and feedback cancellation have become commonplace in the current technology to meet the needs of hearing instrument wearers. The obvious goal of many of these features is to assist with communication in a variety of situations. However, the lifestyles of many hearing instrument wearers demand not only an increase in the processing abilities of the hearing instruments, but also an increase in the physical protection of the hearing instruments. Recently, the aging people over the age of fifty are participating in some form of athletic activity. These types of activities invite a high exposure to moisture from the environment and quite often perspiration. It is apparent that hearing instrument technology needs to not only meet communication demands, but also those demands imposed by physical and outdoor activities.

A significant problem with the hearing aid is that moisture from a variety of sources including perspiration, humidity or precipitation can corrode the inner workings of the hearing aid and render the hearing aid inoperable. This would then subject the hearing aid to expensive repairs or replacements. Hearing aids are often advertised at widely varying prices, from $1,000 US to $5,000 per hearing aid. However, hearing aids are typically not covered, or only partially covered, by most insurance plans in the United States. As a result, it creates tremendous problems for a person with an active lifestyle who participates in sports or enjoys the outdoors.

Specific examples in the prior art illustrate these deficiencies. U.S. Pat. No. 5,249,234 issued to Butler discloses a cover for BTE hearing aids includes a hollow latex body configured similar to, but slightly smaller than, an arcuate BTE hearing aid. The cover possesses a larger quadrilateral closed end and a smaller open end. Opposite arcuate planar sidewalls are connected by a convexly curved top wall and a concavely curved bottom wall. The quadrilateral closed end extends transversely between the sidewalls and the top and bottom walls. The sidewalls and top and bottom walls taper and merge smoothly at the open end to form a circular opening. The cover is formed by dipping a complimentary shaped former into a liquid latex mixture, curing the latex to form a solid cover, and removing the cover from the former. However, these devices require time-consuming attachment and detachment from the BTE hearing aid. Furthermore, these devices make it difficult to change the battery, adjust the volume, and move the switch on the BTE hearing aid.

U.S. Pat. No. 6,540,230, issued to Marx discloses a support for a behind-the-ear hearing aid, including a body and a sound tube that includes at least one pad positioned underneath the behind-the-ear hearing aid, and at least one attachment mechanism that connects the at least one pad to the behind-the-ear hearing aid. This support device can also include a moisture guard that includes a sweat pad located underneath the body of the behind-the-ear hearing aid and also includes a muffler pad located adjacent to the microphone of the hearing aid and is attached to the sound tube of the behind-the-ear hearing aid wherein the at least one attachment mechanism further includes a first attachment mechanism to attach the sweat pad underneath the body of the behind-the-ear hearing aid and a second attachment mechanism to attach the muffler pad to the sound tube and adjacent to the microphone of the behind-the-ear hearing aid. However, these devices do not prevent the sweat from the hair and skin. Further, these devices also require time-consuming attachment and detachment from the hearing because they use attachment mechanism, such as VELCRO (hook and loop fasteners).

It is evident from the above discussion that an ongoing need exists for an improved hearing aid protection device.

Further objectives and advantages of the present invention will become apparent from a careful reading of a detailed description provided hereinbelow, with appropriate reference to accompanying drawings.

### BRIEF SUMMARY OF THE INVENTION

The present invention solves the above and other problems, thereby advancing the state of the useful arts, by providing methods and associated structures for enabling an effective way of preventing sweat from reaching a hearing instrument. It is an aspect of the present invention to provide an apparatus that protects a hearing aid instrument from moisture damage. The apparatus fits over the ear of the user and is situated between the scalp of the user and the hearing aid instrument (which is located in the ear of the user and behind the ear of the user). As a user sweats, the sweat rolls down the scalp of the user. Without the apparatus invention, the sweat comes into contact with the hearing aid instrument. The moisture in the sweat short-circuits the electronics in the hearing aid instrument. With the apparatus invention, the sweat rolls down the scalp of the user. But, the sweat is then blocked from reaching the hearing aid instrument by the apparatus invention. The apparatus invention is made of plastic and is moisture impermeable.

### BRIEF DESCRIPTION OF SEVERAL VIEWS OF THE DRAWINGS

The above and/or other aspects and advantages of the present invention will become apparent and more readily appreciated from the following detailed description, taken in conjunction with the accompanying drawings of which:

FIG. 1 is a perspective view of a hearing aid protection device utilized in conjunction with a conventional behind-the-ear (BTE) hearing aid and in accordance with one embodiment of the present invention;

FIG. 2 is an exploded view of a hearing aid protection device and a conventional behind-the-ear (BTE) hearing aid in accordance with one embodiment of the present invention;

FIG. 3 is a front elevational view of a hearing aid protection device utilized in conjunction with a conventional behind-the-ear (BTE) hearing aid in accordance with one embodiment of the present invention;

FIG. 4 is a back elevational view of a hearing aid protection device utilized in conjunction with a conventional behind-the-ear (BTE) hearing aid in accordance with one embodiment of the present invention.

### DETAILED DESCRIPTION OF THE INVENTION

Reference will now be made in detail to exemplary embodiments of the present invention, examples of which are illustrated in the accompanying drawings, wherein like reference numerals refer to the like elements throughout. The exemplary embodiments are described below in order to explain the present invention by referring to the figures.

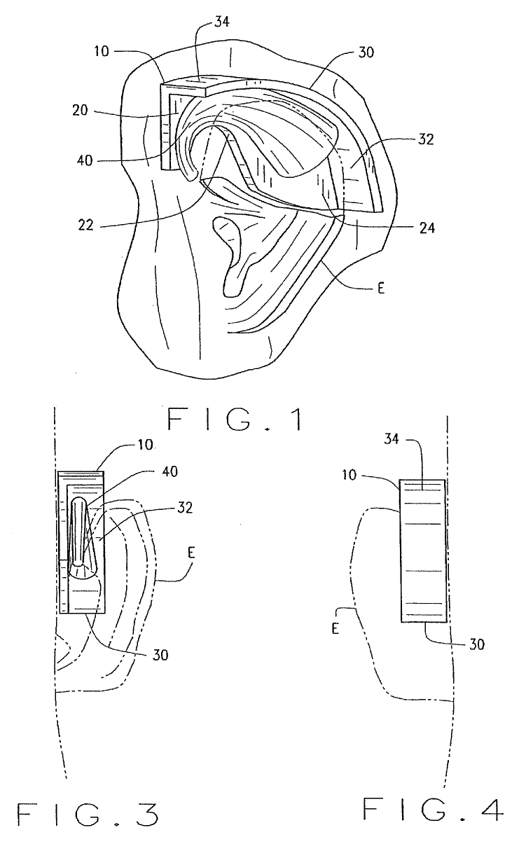

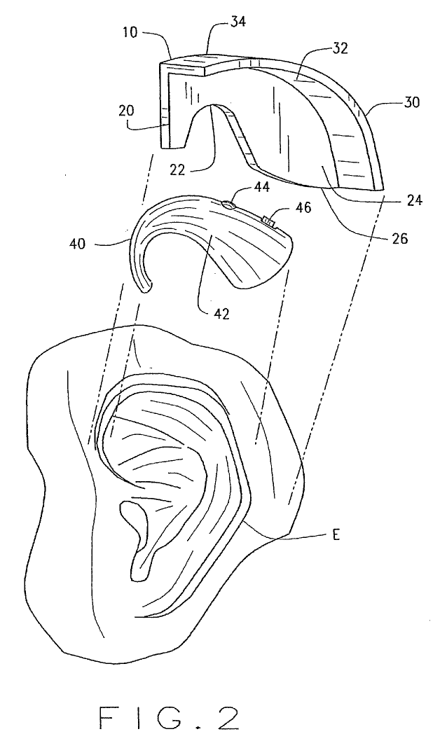

FIGS. 1-4 illustrate the present invention in accordance with one of its embodiments. Referring now to the drawings, and initially to FIG. 2, a typical behind-the-ear “BTE” hearing aid is illustrated and generally indicated by numeral 40. The BTE hearing aid 40 has a body 42 that is generally curved in an arcuate manner and is typically worn on the upper rear portion of a person's ear E. The body 42 of the BTE hearing aid 40 houses an electronic amplifier, battery, and filtering circuitry (not shown). The electronic amplifier is typically very sensitive. There is a microphone that is located on the front portion of the BTE hearing aid 40 that picks up ambient sound waves and transmits them to the filtering and sensitive amplification circuitry (not shown) that is located in the body 42 of the BTE hearing aid 40.

The BTE hearing aid 40 typically, but not necessarily, includes a rotatable volume control wheel 44 and a switch 46 on a top of the body 42 that can be operated by the person using the BTE hearing aid 40, as shown in FIG. 2. This allows the individual to switch between microphone usage to telecoil usage if the person is using the phone or turning the BTE hearing aid 40 off altogether. There is a battery compartment that is hingedly mounted on a pivot pin to provide access to a small cylindrical zinc battery (not shown). Although the cylindrical zinc battery is preferred, any type of battery utilized with hearing aids will suffice. Some of these zinc batteries require exposure to air in order to complete the chemical reaction.

The hearing aid protection device is generally indicated by numeral 10, as shown in FIGS. 1-4. The hearing aid protection device 10 comprises a base 20 and a ridge 30, which perform the function of a moisture guard. The hearing aid protection device 10 fits over the ear E of the user and is positioned between the scalp of the user and the hearing aid 40.

Referring again to FIGS. 1 and 2, the base 20 rests between the scalp of the user and the hearing aid 40, which covers a substantial portion of one side of the hearing aid 40. The base 20 comprises an inner surface 24, an outer surface (not shown) and a contoured edge 22. The inner surface 24 of the base 20 faces and accommodates one side wall of the hearing aid 40 case. The base 20 blocks any sweat from the user's scalp from reaching the hearing aid 40. The base 20 is configured and sized to accommodate the hearing aid 40. In one embodiment, the contoured edge 22 is bowed inwardly in a concave manner for positioning the hearing aid protection device 10 against the ear E, whereby the hearing aid protection device 10 is snuggly positioned against the ear E following the shape of the rear saddleback portion of the user's ear E. The contoured edge 22 of the base 20 is curved and configured to substantially follow a shape of the ear E from the top of the ear E and down to the rear saddleback portion of the user's ear E (that is, over the auricle of a human ear). The contoured edge 22 is configured and sized to fit the user's ear E. In one embodiment, the contour shape of the contoured edge 22 of the base 20 matches and accommodates the rear saddleback portion of the human ear E. The hearing aid protection device 10 is mounted or secured at about the saddleback portion of the user's ear E with the contoured edge 22. The base 20 further comprises the outer surface (not shown) that faces away from the hearing aid 40 and faces the user's scalp.

The ridge 30 is extended from the upper edge of the base 20. The ridge 30 projects above an inner surface 24 of the base 20. The ridge 30 projects substantially perpendicular to the base 20. The ridge 30 extends along the upper edge of the base 20, which forms a guard, a flap, or a side wall to prevent the sweat from the user's hair skin from reaching the hearing aid 40. In one embodiment, the ridge 30 is securely or rigidly attached to the base 20. In some embodiments, ridge 30 may be formed with base 20 as a single unitary body. The ridge 30 is sized to substantially block the sweat from the user's hair or hair scalp.

In one embodiment, mounting/demounting of the hearing aid 10 can be effected by elastic deformation of the base 20 and the contoured edge 22 but this is not necessarily the case. In another embodiment, mounting/demounting of the hearing aid 10 can also be effected without any elastic deformation.

The preferred material for the hearing aid protection device 10 is water-blocking or moisture impermeable material, such as vinyl plastic, polyester polyurethane, polyether foam material or the like. However, a host of other materials will suffice including, but not limited to: expanded foam, e.g., polyolefin foam; rubber foam; reticulated foam; silicone foam; synthetic latex; latex foam; and cloth interfacing or similar material.

Although a few exemplary embodiments of the present invention have been shown and described, the present invention is not limited to the described exemplary embodiments. Instead, it would be appreciated by those skilled in the art that changes may be made to these exemplary embodiments without departing from the principles and spirit of the invention, the scope of which is defined by the claims and their equivalents.

The terminology used in the description of the invention herein is for the purpose of describing particular embodiments only and is not intended to be limiting of the invention. As used in the description of the embodiments of the invention and the appended claims, the singular forms “a”, “an” and “the” are intended to include the plural forms as well, unless the context clearly indicates otherwise.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety.

It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. It will be understood that relative terms are intended to encompass different orientations of the device in addition to the orientation depicted in the Figures.

Moreover, it will be understood that although the terms first and second are used herein to describe various features, elements, regions, layers and/or sections, these features, elements, regions, layers and/or sections should not be limited by these terms. These terms are only used to distinguish one feature, element, region, layer or section from another feature, element, region, layer or section. Thus, a first feature, element, region, layer or section discussed below could be termed a second feature, element, region, layer or section, and similarly, a second without departing from the teachings of the present invention.

Thus, there has been shown and described several embodiments of a novel invention. As is evident from the foregoing description, certain aspects of the present invention are not limited by the particular details of the examples illustrated herein, and it is therefore contemplated that other modifications and applications, or equivalents thereof, will occur to those skilled in the art. The terms “having” and “including” and similar terms as used in the foregoing specification are used in the sense of “optional” or “may include” and not as “required”. Many changes, modifications, variations and other uses and applications of the present construction will, however, become apparent to those skilled in the art after considering the specification and the accompanying drawings. All such changes, modifications, variations and other uses and applications which do not depart from the spirit and scope of the invention are deemed to be covered by the invention which is limited only by the claims which follow.

The scope of the disclosure is not intended to be limited to the embodiments shown herein, but is to be accorded the full scope consistent with the claims, wherein reference to an element in the singular is not intended to mean “one and only one” unless specifically so stated, but rather “one or more.” All structural and functional equivalents to the elements of the various embodiments described throughout this disclosure that are known or later come to be known to those of ordinary skill in the art are expressly incorporated herein by reference and are intended to be encompassed by the claims.

What is claimed is:

1. A hearing aid protection device comprising:
a base, the base having a contoured edge, an upper edge, an inner surface and an outer surface; and
a ridge coupled to the base proximate to the upper edge of the base, the ridge extending away from the base;
wherein the contoured edge is configured to generally accommodate a rear saddleback portion of a user's ear.

2. The hearing aid protection device of claim 1, wherein the base is configured to be placed between a behind the ear type hearing aid and a scalp of a user.

3. The hearing aid protection device of claim 1, wherein the upper edge is generally parallel with a portion of the contoured edge.

4. The hearing aid protection device of claim 1, wherein the ridge extends generally perpendicular to the base.

5. The hearing aid protection device of claim 1, wherein the base and the ridge are formed as a single unitary body.

6. The hearing aid protection device of claim 1, wherein the device comprises a water impermeable material.

7. The hearing aid protection device of claim 6, wherein the water impermeable material is polymeric.

8. A hearing aid protection device comprising:
a base, the base having a contoured edge configured to generally accommodate a rear saddleback portion of a user's ear, an upper edge that is generally parallel to at least a portion of the contoured edge, an inner surface and an outer surface; and
a ridge coupled to the base proximate to the upper edge of the base, the ridge extending away from the base;

9. The hearing aid protection device of claim 8, wherein the base is configured to be placed between a behind the ear type hearing aid and a scalp of a user.

10. The hearing aid protection device of claim 1, wherein the base is configured to be placed between a behind the ear type hearing aid and a scalp of a user.

11. The hearing aid protection device of claim 1, wherein the base and the ridge are formed as a single unitary body.

12. The hearing aid protection device of claim 1, wherein the device comprises a water impermeable material.
